(19) United States
(12) Patent Application Publication
(10) Pub. No.: US 2009/0121454 A1
(43) Pub. Date: May 14, 2009

(54) Grip Device, Particulary for Pushchairs, Prams ans the Like

(76) Inventors: Ivan Tomasi, Sovizzo (IT); Roberto Gorza, Feltre (IT); Nicola Marchiori, Camisano Vicentino (IT)

Correspondence Address: Modiano & Associati, Via Meravigli 16, 20123, Milan, IT

(21) Appl. No.: 12/083,563

(22) PCT Filed: Oct. 12, 2006
(86) PCT No.: PCT/EP2006/009865

§ 371 Date: Apr. 14, 2008

(30) Foreign Application Priority Data
Oct. 18, 2005 (IT) VR2005A000131

(51) Int. Cl. B62B 9/20; B62B 7/08

(52) U.S. Cl. 280/642

(57) ABSTRACT

A grip device, particularly for pushchairs, prams and the like, comprising a connecting body provided with a plurality of connecting elements, which comprise two connecting ends, coupled to a respective connecting element formed at a respective side of a frame for pushchairs designed to pass from a closed or collapsed condition to an open or extended condition and vice versa; the grip device has at least two connecting portions, which are articulated to each other and connect the two connecting ends, and a device for locking at least one pair of connecting elements when the frame is in the extended condition. The grip device comprises at least one locking device, which acts between a pair of contiguously arranged connecting elements to lock on command the rotation of one connecting element with respect to the other, a remote actuation device for the locking device being provided.

### TECHNICAL FIELD

The present invention relates to a grip device, particularly for pushchairs, prams and the like.

### BACKGROUND ART

Currently, some frames for pushchairs and prams have a grip device which lies between the two ends of the handle tubes that are arranged upwardly during use, connecting them to each other.

Such kinds of grip devices allow, in some circumstances, more convenient use, since they can be gripped for example with just one hand.

However, although such grip devices are now widely used, they suffer drawbacks especially if they are fitted to frames for pushchairs of the type known as umbrella-folding due to the particular manner in which they close.

Such pushchair frames in fact fold both transversely and longitudinally (therefore in three dimensions) until they assume, when closed, a shape which can be likened to a closed umbrella.

It is evident that if one wishes to associate the grip device described above with umbrella-folding frames, it is necessary to provide such device in two or more connecting portions, which are rotatably articulated to each other so as to allow the transition of the frame from the extended condition to the collapsed condition. In any case, it is evident that in order to ensure sufficient rigidity of the grip device during use (and therefore when the frame is in the extended condition), it is advantageous to provide on such grip device means for locking mutual rotation among the different connecting portions.

Several constructive solutions have been proposed in this regard but have not proved to be devoid of drawbacks.

The most widely used solutions mutually connect the connecting portions that constitute the grip device by means of joints between which locking elements, which can be actuated manually by the user, act.

Although such solutions allow to obtain, when the frame is in the extended position, a certain rigidity of the grip device, they have a certain awkwardness in use, owing to the fact that the user is forced, after placing the frame in the extended condition, to act on the locking elements in order to lock each joint. The same action must of course be reverse-performed before placing the frame in the collapsed condition.

### DISCLOSURE OF THE INVENTION

The aim of the present invention is to eliminate or at least reduce drastically the drawbacks noted currently in grip devices particularly for pushchairs, prams and the like described above.

Within this aim, an object of the invention is to provide a grip device which has such characteristics as to allow simplification of the operations for opening and closing the frame with which it is associated.

Another object of the present invention is to provide a grip device which is easy to use and offers the greatest assurances of reliability during operation.

Still another object of the invention is to devise a grip device which is constructively very simple and has a low production cost, so that its use is advantageous also from an economical standpoint.

This aim and these and other objects are achieved by a grip device, particularly for pushchairs, prams and the like, comprising a connecting body provided with a plurality of connecting elements, which comprise two connecting ends, which are coupled to a respective connecting element provided at a respective side of a frame for pushchairs designed to pass from a closed or collapsed condition to an open or extended condition and vice versa, said grip device having at least two connecting portions, which are articulated to each other and connect said two connecting ends, means for locking said grip device with said frame in the open or extended condition being provided, said locking means comprising at least one locking device, which acts between a pair of contiguously arranged connecting elements and is adapted to lock on command the rotation of one connecting element with respect to the other, characterized in that it comprises means for the remote actuation of said at least one locking device.

### BRIEF DESCRIPTION OF THE DRAWINGS

Further characteristics and advantages will become better apparent from the description of some preferred but not exclusive embodiments of a grip device according to the invention, illustrated by way of non-limiting example in the accompanying drawings, wherein:

FIG. 1 is a perspective view of a pushchair frame provided with a grip device according to the invention in the fully extended condition;

FIG. 2 is a view, similar to FIG. 1, of a frame for pushchairs in the collapsed condition;

FIG. 3 is a view of the frame shown in FIGS. 1 and 2 in an intermediate condition;

FIG. 4 is a partially sectional top view of a grip device according to the present invention;

FIG. 5 is an enlarged-scale view of a detail of the grip device shown in FIG. 4;

FIG. 6 is a sectional view of the grip device, taken along the plane of arrangement defined by the line VI-VI of FIG. 4;

FIG. 7 is a schematic top elevation view of a variation of the grip device according to the invention;

FIG. 8 is a view of another variation of a grip device, shown in cross-section in order to illustrate schematically the locking means;

FIG. 9 is an enlarged-scale view of a locking device shown in FIG. 8;

FIG. 10 is an enlarged-scale view of a particular form of connection between the grip device and a respective side of a pushchair frame;

FIG. 11 is a sectional view of the grip device, taken along the plane of arrangement designated by the line XI-XI of FIG. 8 and in which part of the outer enclosure has been omitted for the sake of clarity;

FIG. 12 is an enlarged-scale view of a locking device shown in FIG. 11;

FIG. 13 is a view, taken from the same viewpoint as FIG. 11, of a grip device with the frame in the collapsed condition;

FIG. 14 is an enlarged-scale view of a locking device shown in FIG. 13;

FIG. 15 is a side elevation view of an umbrella-folding frame provided with a grip device according to the invention and in which parts of the outer enclosures of the front uprights have been omitted for the sake of clarity;

FIG. 16 is another side elevation view, but in enlarged scale, of the mechanism for locking/releasing the frame in the extended condition shown in FIG. 15;

FIG. 17 is another partially sectional side elevation view, but in enlarged scale, of the region for connection between the side and the grip device of the frame in the extended condition shown in FIG. 15;

FIG. 18 is another side elevation view, but in enlarged scale, of the lower portion of the front upright with the frame in the extended condition shown in FIG. 15;

FIG. 19 is a side elevation view of an umbrella-folding frame provided with a grip device according to the invention and in which parts of the outer enclosures of the front uprights have been omitted for the sake of clarity, during actuation of the actuation device;

FIG. 20 is another side elevation view, but in enlarged scale, of the mechanism for locking/releasing the frame in the condition shown in FIG. 19, during actuation of the actuation device;

FIG. 21 is another partially sectional side elevation view, but in enlarged scale, of the region of connection between the side and the grip device of the frame in the condition shown in FIG. 19;

FIG. 22 is another side elevation view, but in enlarged scale, of the lower portion of the front upright, with the frame in the condition shown in FIG. 19;

FIG. 23 is a schematic view of another variation of the grip device, in which the (upper and lower) front upright is associated with the locking/release mechanism, with the frame in the extended condition;

FIG. 24 is a schematic view of the (upper and lower) front upright associated with the locking/release mechanism during actuation of the locking/release mechanism;

FIG. 25 is a schematic view of the (upper and lower) front upright associated with the locking/release mechanism with the frame in the collapsed or intermediate condition.

### WAYS OF CARRYING OUT THE INVENTION

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

With reference to the figures, a grip device particularly for pushchairs, prams and the like is generally designated by the reference numeral 1 and comprises a connecting body 2, which is composed of a plurality of connecting elements 30.

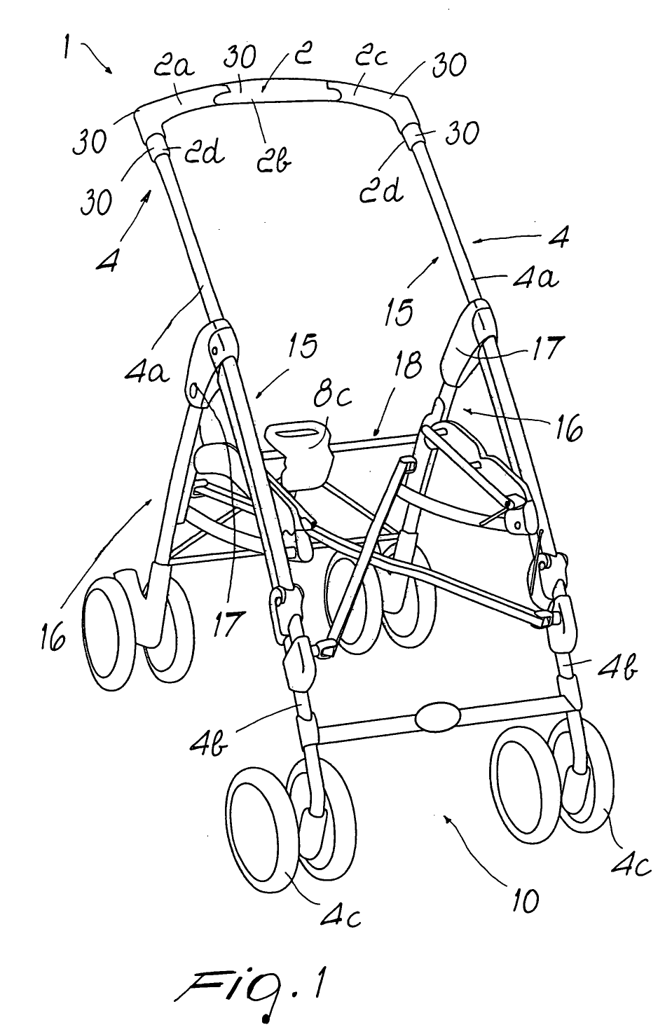

In particular, the connecting elements 30 comprise two connection ends 2d which are coupled, as explained in greater detail hereinafter, to a respective connecting element 3, which is provided at a respective side 4 of a frame 10 for pushchairs, prams and the like: with reference to the embodiment shown in FIGS. 1 to 3, the frame 10 can be of the so-called umbrella-folding type and the connecting elements 3 can, in this and other cases, be constituted by the ends of the handle tubes (also referenced as upper front uprights) 4a of said frame 10 that are arranged upwardly during use.

With particular reference first of all to FIGS. 1 to 3, the connecting body 2 comprises at least two connecting portions which are mutually articulated about a respective rotation axis 100. In particular, in the examples shown in the figures, the connecting body comprises three connecting portions (2a, 2b and 2c), which are mutually articulated in pairs about a respective rotation axis 100.

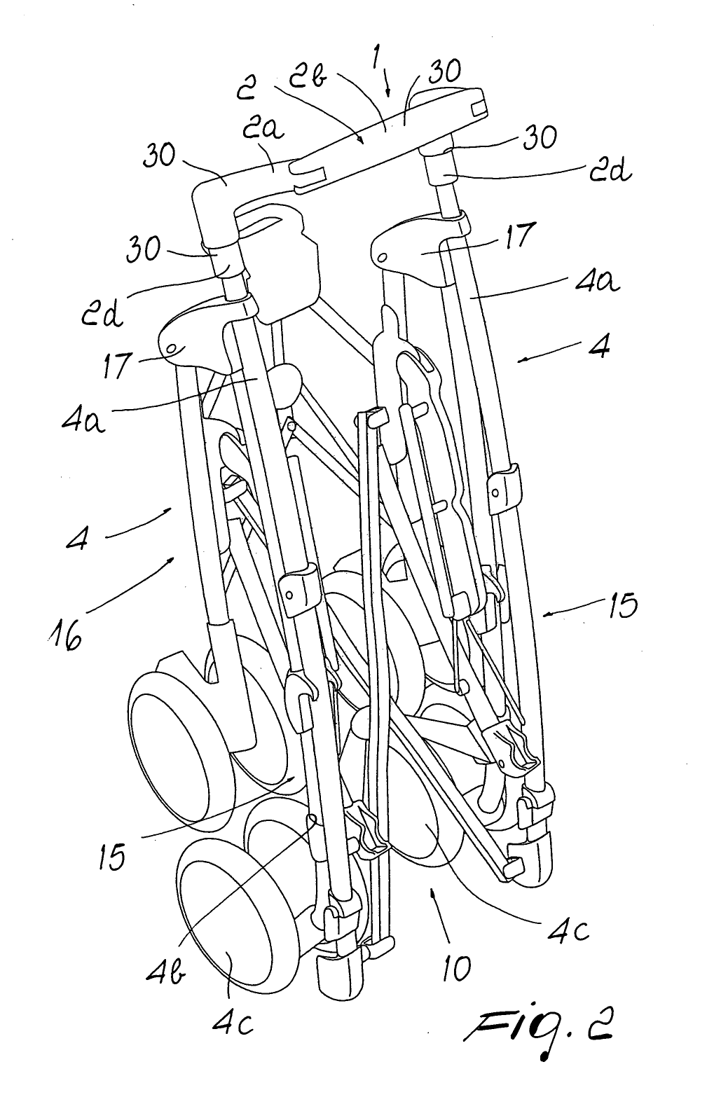

The frame 10 is meant to pass from an extended (or open) condition, shown in FIG. 1, to a collapsed (or closed) condition, shown in FIG. 2, and vice versa: in particular, it is evident that when the frame 10 is in the extended condition the sides 4 are spaced one another, while when the frame 10 is in the collapsed condition the sides 4 (as shown in FIG. 2) are closer.

During the transition of the frame 10 from the extended condition to the collapsed condition and vice versa, the connecting portions 2a, 2b and 2c rotate about the respective rotation axis 100.

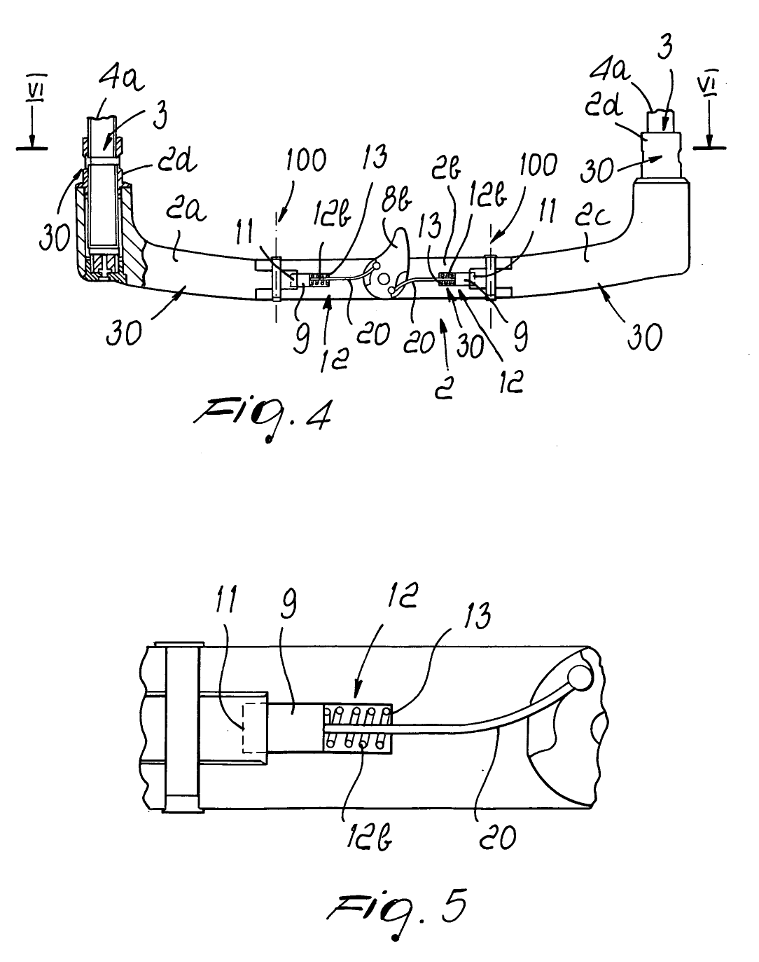

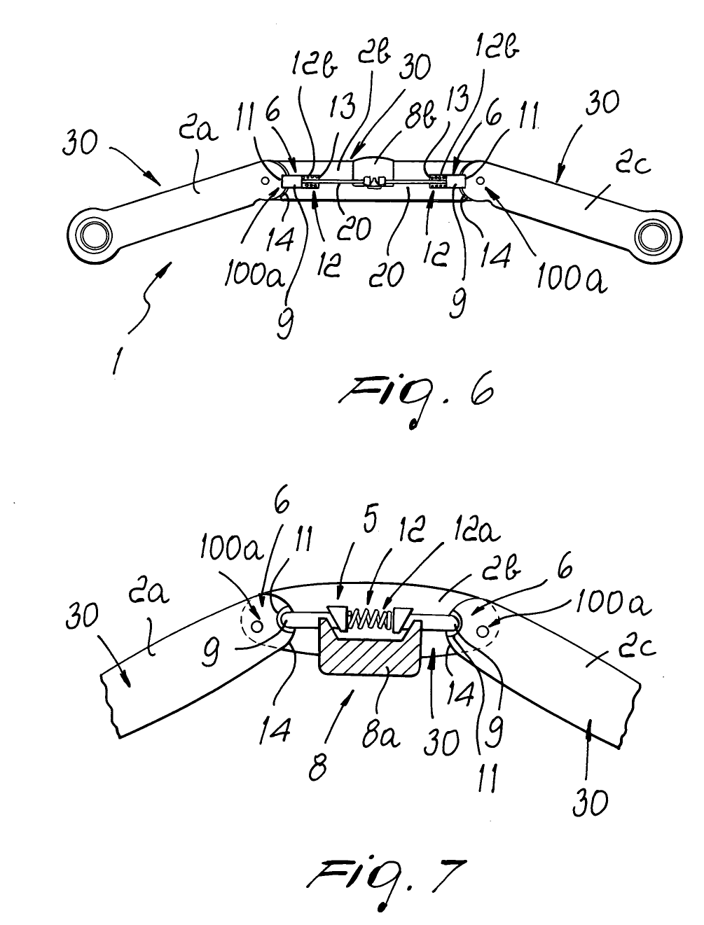

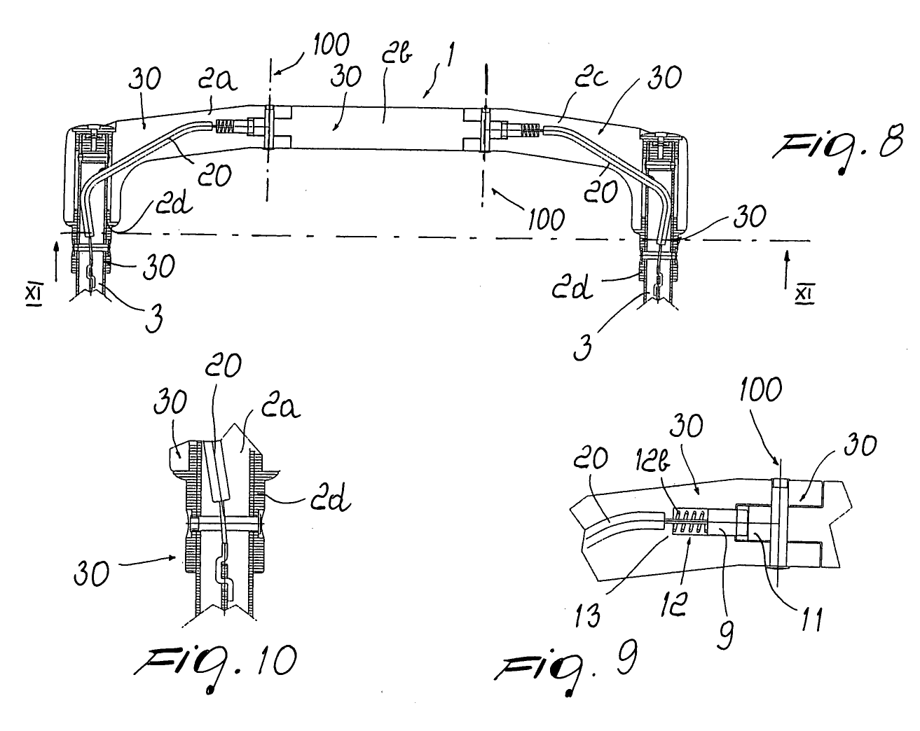

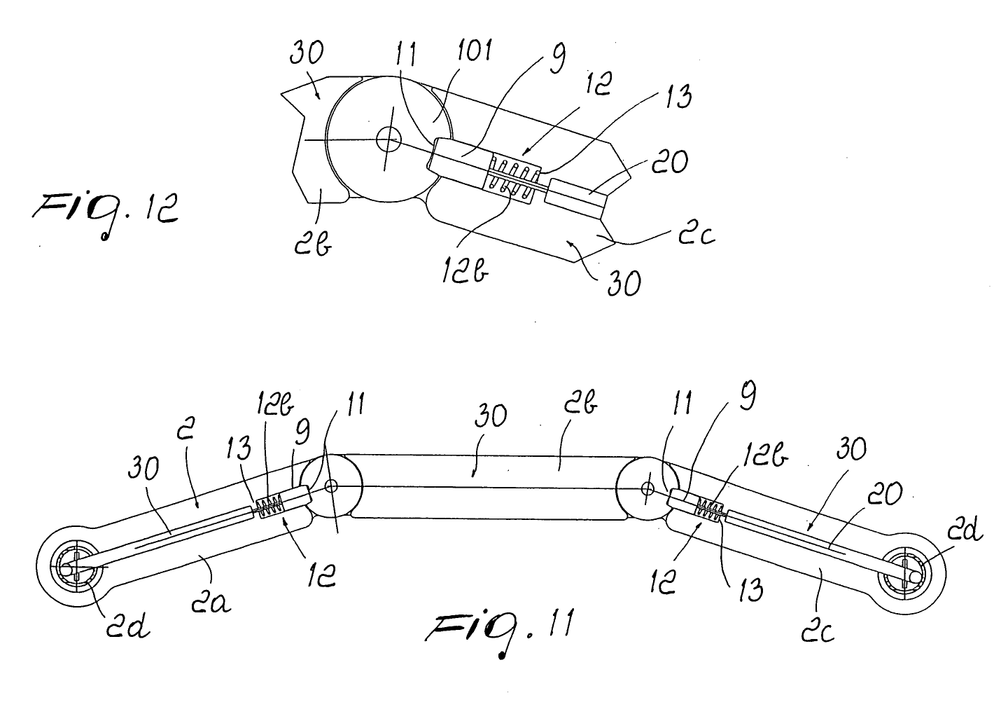

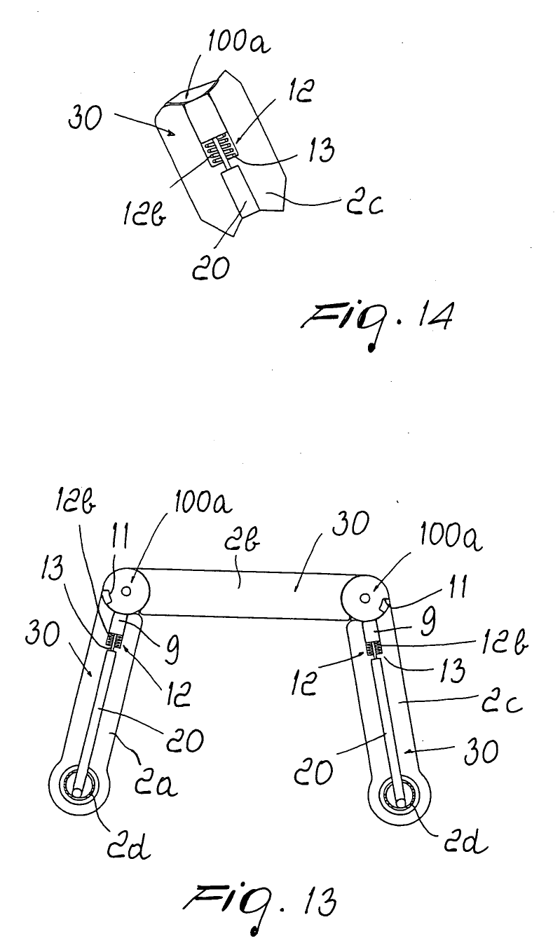

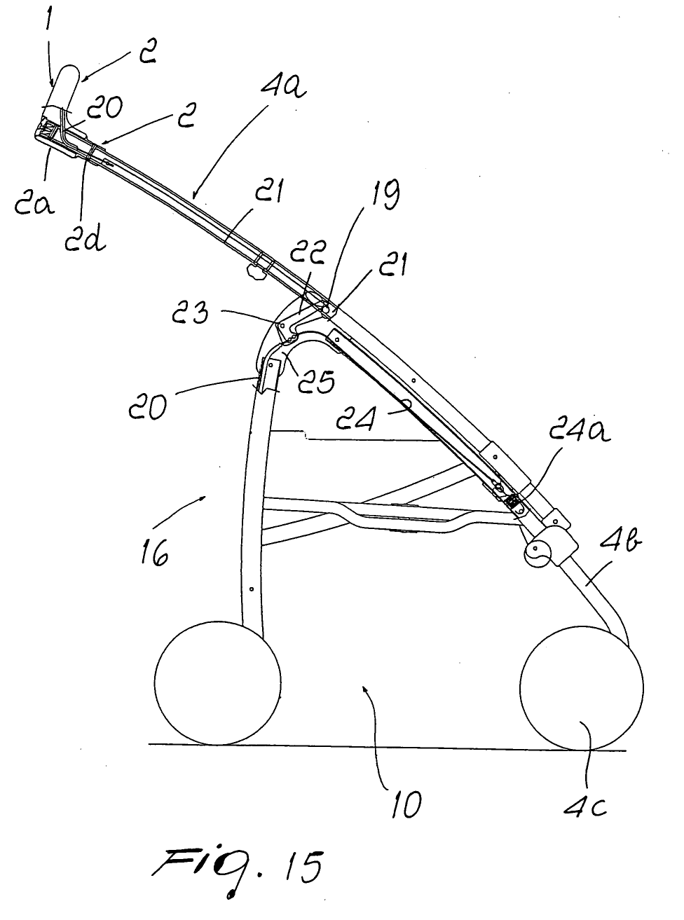

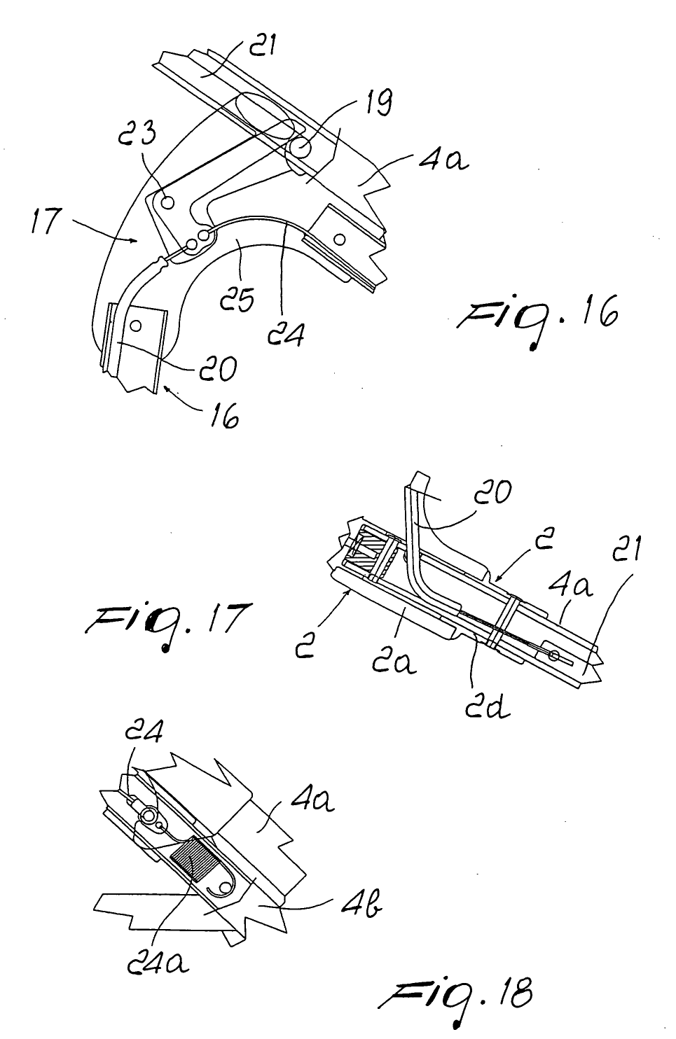

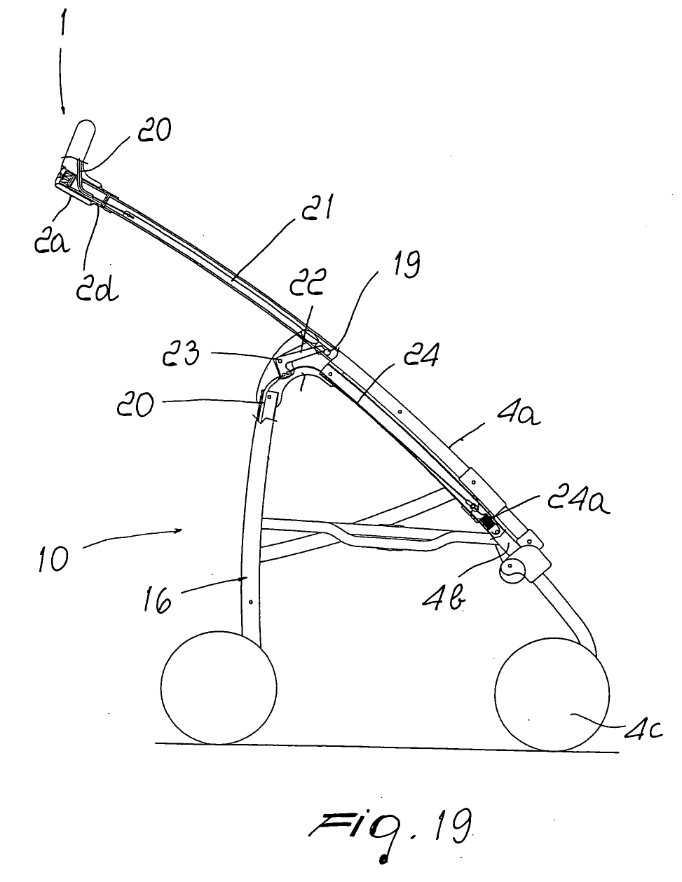

The grip device 1 is provided with locking means 5, which comprise at least one locking device 6 which acts between at least one pair of connecting elements 30 and in particular, in the constructive variations shown in FIGS. 6 to 21, between at least one pair of connecting portions (2a, 2b; 2b, 2c) which are mutually articulated about their respective rotation axis 100 and are therefore arranged contiguously: in particular, the locking device or devices is/are adapted to lock the relative rotation of the respective pair of connecting portions (2a, 2b; 2b, 2c) when the frame 10 is moved to the extended condition. It is evident that in the illustrated embodiments, during the transition of the frame from the collapsed condition to the extended condition and vice versa, the connecting portions arranged at the ends (and therefore the connecting portions 2a and 2c) rotate also about a second axis of rotation, which corresponds substantially to the longitudinal direction of the upper upright 4c and with respect to the connecting elements 30 which provide the connecting ends 2d.

In greater detail, the or each locking device 6 is adapted to lock (or release) on command the rotation of one connecting element with respect to the other about the respective rotation axis 100.

According to a first aspect of the present invention, the locking means 5 comprise means for remotely actuating the locking device or devices 6.

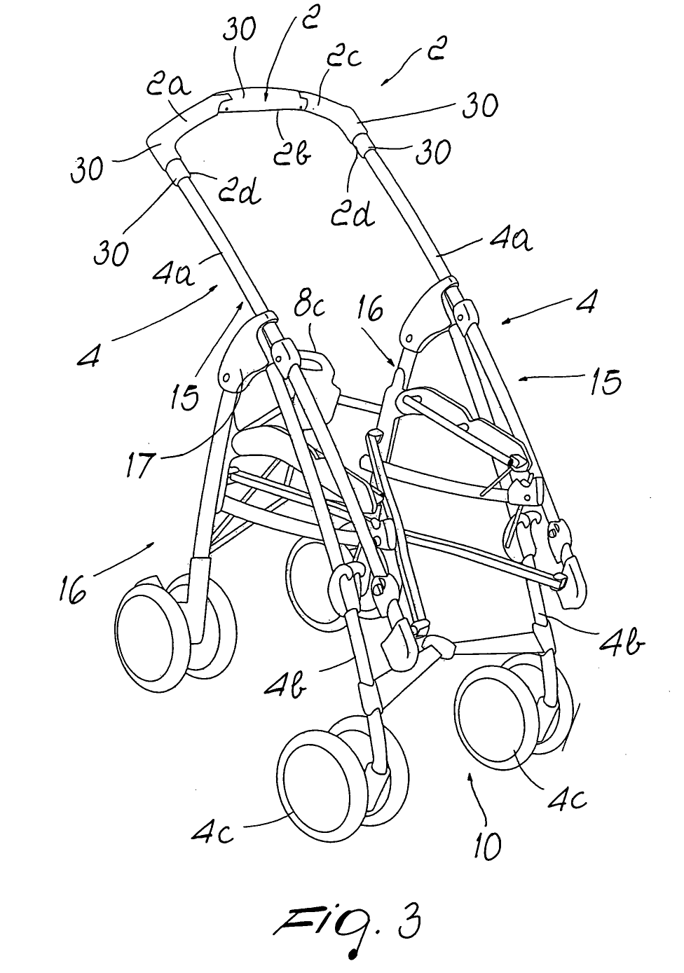

As shown in the embodiments illustrated in FIGS. 4 to 7, the locking means 5 can comprise at least two locking devices 6, each of which acts on a pair of connecting portions (2a, 2b; 2b, 2c) which are contiguous and are articulated to each other at an articulation node 100a: in this case, it is advantageous to provide the remote actuation means so that they are adapted to act substantially simultaneously on the two (or more) locking devices 6.

Conveniently, the remote actuation means can be provided by an actuation device 8 (such as an actuation button 8a, as shown in FIG. 7, or an actuation lever system 8b, as in the embodiment shown in FIGS. 4 to 6).

In these particular embodiments, each of the two locking devices provides for the presence of one or more engagement teeth 9 (which in the illustrated examples are supported by the connecting portion 2b), which are connected kinematically, for example by means of a respective cable 20, which is optionally sheathed, to the actuation device 8: the engagement tooth or teeth 9 can be engaged, when the frame 10 is in the extended condition, in a respective engagement seat 11, which is supported by the connecting portions (in this case 2a and 2c) which are articulated (at the pivoting node 100a) to the connecting portion 2b on which the engagement teeth 9 are provided.

In order to allow the engagement teeth 9 to remain engaged within the respective engagement seat 11 so as to prevent the relative rotation of the pairs of connecting portions 2a, 2b; 2b, 2c about the respective axis of rotation 100, it is convenient for said engagement teeth 9 to be associated with loading means (constituted advantageously by springs 12), which are designed to keep said engagement teeth 9 loaded in order to press within the respective engagement seat 11.

The loading means can be provided by providing a single interconnection spring 12a, which is rigidly connected, at its ends, to an engagement tooth 9 and can be compressed by moving the actuation button 8a in order to disengage each engagement tooth 9 from the respective engagement seat 11.

As an alternative, as shown in FIGS. 4 to 6, it is possible to provide a loading spring 12b, which acts between each engagement tooth 9 and an abutment recess 13 provided on the connecting portion (in this case, the connecting portion 2b) which supports the engagement tooth or teeth. Such spring, as in the previously described case, is loaded so as to keep the engagement tooth or teeth 9 associated therewith pressed within the respective engagement seat 11 when the frame 10 is in the extended condition and therefore when the grip device 1 is in the condition shown in FIGS. 4 and 6.

By actuating the actuation device 8, the engagement tooth or teeth 9 is/are disengaged from the respective engagement seat 11, allowing in this way the relative rotation of the pairs of connecting portions 2a, 2b; 2b, 2c about the respective rotation axis 100. The or each engagement seat 11 is shaped so that the engagement tooth or teeth 9, once disengaged from the respective engagement seat 11, can slide freely at the region identified by the respective pivoting node 100a.

In this regard, as can be seen in the schematic views shown in FIGS. 4 and 7, it is possible to provide, on the connecting portion 2a and 2c that forms the engagement seat 11, proximate to the edges of said seat 11, a sliding portion for the engagement tooth or teeth 9, which is constituted for example by a portion arranged along a circular arc 14 which is centered at the axis of rotation 100.

According to a particular embodiment, the grip device 1 can be associated with a frame 10 which has two sides 4, each of which comprises a respective front upright 15 and a respective rear upright 16.

The front upright 15 comprises a respective upper upright (also referenced as handle tube), already designated by the reference numeral 4a, and a lower upright 4b, which supports a wheel assembly 4c; said uprights are kinematically connected to each other by way of the interposition of a locking/release mechanism 17 which will be described in greater detail hereinafter.

Between the two rear uprights 16 there is an articulated interconnection structure 18, which is constituted generally by a so-called “double parallelogram” for interconnection between the two rear uprights 16 and is adapted to allow, during the transition of the frame 10 from the extended condition to the collapsed condition and vice versa, to keep the rear uprights 16, and therefore consequently the sides 4, parallel to each other.

On at least one, but advantageously on both, of the sides 4 there is, as mentioned, a locking/release mechanism 17, which is adapted to allow (or prevent) the relative movement between the upper upright 4a and the respective lower upright 4b during the transition of the frame 10 from the extended condition to the closed or collapsed condition and vice versa.

According to an important aspect of the present invention, the remote actuation device 8 provided on the grip device 1 is kinematically connected not only to the (or each) locking device 6, but also to the (or each) locking/release mechanism 17 between the respective lower and upper uprights 4b and 4a.

In practice, by acting exclusively on a single device, one obtains the release both of the locking/release mechanism 17 (in order to allow the closure of the frame by allowing rotary and translational motion between the upper upright 4a and the respective lower upright 4b) and of the locking devices 6 in order to allow the relative rotation of the connecting portions (2a, 2b; 2b, 2c) about the respective rotation axis 100.

Conveniently, the actuation device 8 can be provided at a lifting handle 8c, which is arranged substantially at the articulated interconnection structure 18.

In this regard, it is possible to connect, by means of separate sheathed cable portions 20, the lifting handle 8c arranged at the articulated interconnection structure 18 to the (or each) locking device 6 and to the (or each) locking/release mechanism 17.

However, there is nothing to prevent the provision of a sheathed cable 20 (or of course of a technically equivalent element, such as a rod or a flexible cable) for connection between the lifting handle 8c and the locking/release mechanism 17 and, in turn, an additional sheathed cable 20, which connects the locking/release mechanism 17 (and in particular a portion thereof which can be moved during the actuation of the locking/release mechanism 17 following the intervention of the user on the actuation device 8) to the (or to a respective) locking device 6 formed on the grip device 1.

It is of course evident that it is fully equivalent to provide a first portion of sheathed cable 20 designed to connect the actuation device 8 to one or more locking devices 6 and a second portion of sheathed cable 20 which connects said locking device or devices 6 to the locking/release mechanism or mechanisms 17.

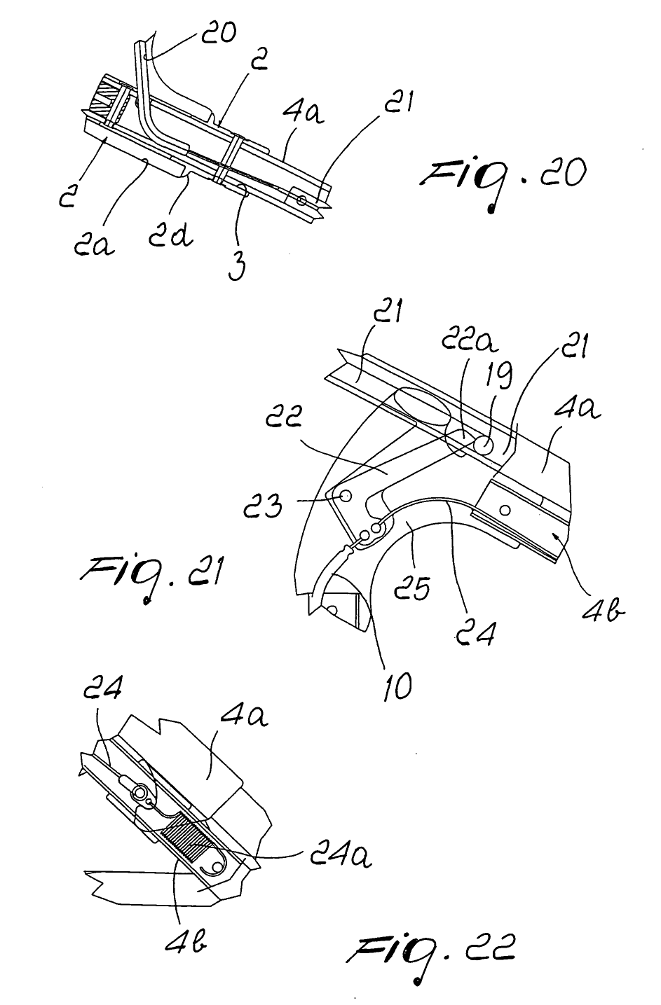

With particular reference to the embodiments shown in FIGS. 11 to 22, it can be seen that in this case the portion of cable 20 that is designed to actuate the locking devices 6 of the grip device 1 is connected to an actuation pin 19, which is supported by an actuation rod 21 which is mounted so that it can slide in an axial direction with respect to the handle tube 4a. The actuation pin 19 can be engaged by a release lever system 22, which is mounted so that it can rotate about an oscillation pivot 23 on a support 25 for connection between the rear upright 16 and the respective front upright 15.

The release lever system 22 is kept loaded by a tensioning cable 24, which has, along its extension, a tensioning spring 24a and is anchored to the lower end of the lower upright 4b.

In this particular embodiment, it is convenient to provide means for actuating the release lever system 22, which can be arranged in the vicinity of the grip device 1 or, as shown, at the lifting handle 8c. In this case, of course, it is convenient to provide a second portion of sheathed cable 20 (or, in a manner similar to what has been mentioned earlier, a similar kinematic connecting element) which is designed to connect the lifting handle 8c to the release lever system 22: it is evident that by means of the actuation rod 21 and the first portion of sheathed cable 20 the lifting handle 8c, when actuated, produces an action not only on the locking/release mechanism 17 but also on the (or each) locking device 6.

In a manner which is fully equivalent from the conceptual standpoint, the locking means 5 can act between the connecting ends 2d and the connecting portions articulated thereto, which in the embodiments shown in the drawings are designated by the reference numerals 2a and 2c.

With particular reference in this case to FIGS. 23 to 25, the locking device 6 can be provided by providing a locking assembly 26, which can move along the longitudinal direction of the upper upright (or handle tube) 4a, following the actuation of the remote actuation means and in particular, in the illustrated case, following the actuation of the locking/release mechanism 17.

In particular, in this embodiment, the connecting ends 2d are constituted in practice by said locking assemblies 26, which, when the frame 10 is in the extended condition, are loaded, by way of the action of elastic means 27 which act between the upper upright (or handle tube) 4a and the actuation rod 21 associated therewith, so as to press against a complementarily shaped abutment portion 28 which is provided at the connecting portions 2a and 2c, which form part of the grip device 1.

It is evident that in this particular embodiment it is not necessary to provide locking devices 6 which act between pairs of connecting portions, since the locking of the connecting portions 2a, 2c with respect to the connecting ends 2d inherently ensures the stability of the entire grip device 1.

According to a last important aspect, also shown in the schematic FIGS. 23 to 25 but applicable to all the embodiments shown and described previously, the or each locking device 6 can be associated with an actuation device 31, which is adapted to allow the mutual locking of the respective pair of connecting elements 2 only when the frame 10 is in a fully open or extended condition.

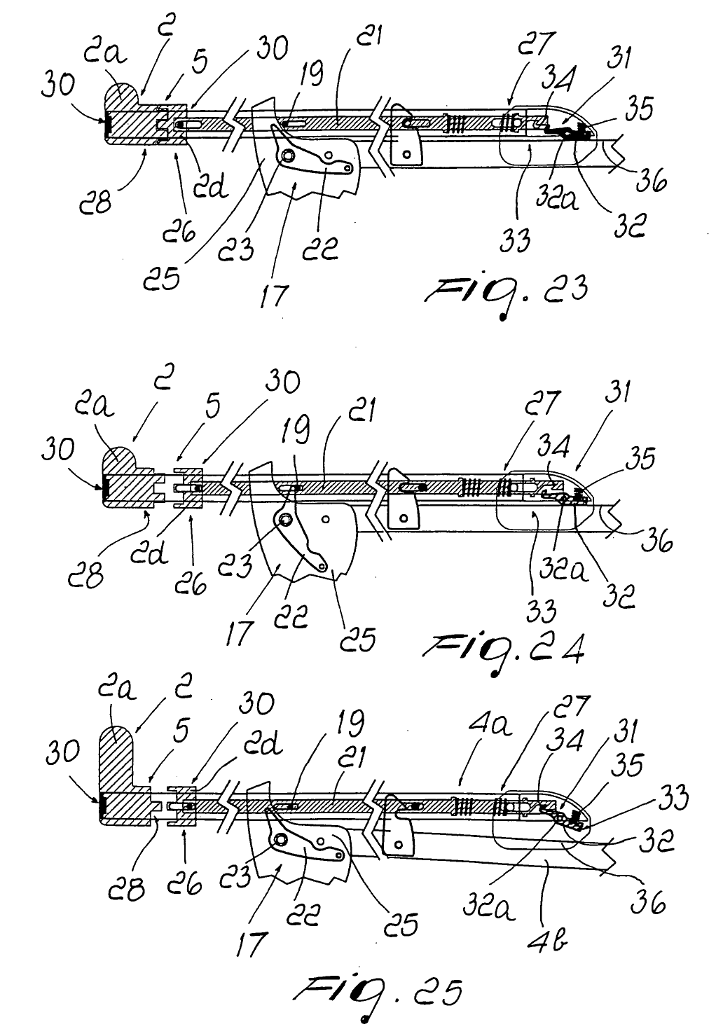

According to a first exemplary of embodiment, the actuation device 31 comprises an opening sensor 32, which is meant to pass between an active condition (shown in FIGS. 23 and 24) when the frame is in the open or extended condition and an inactive condition (shown in FIG. 25) when the frame 10 is not in the open or extended condition.

The sensor 32 can comprise a hook which is mounted so that it can oscillate about a respective oscillation pivot 32a with respect to a lower support 33, which is fixed to the handle tube 4b and is kept, in the inactive condition, engaged with a respective engagement portion 34, which is rigidly coupled to the actuation rod 21, by a loading spring 35.

When the frame 10 moves to the fully extended condition (shown in FIGS. 23 and 24), the hook is designed to abut against an abutment portion 36 provided on the lower upright 4b: this produces the compression of the loading spring 35 and the consequent disengagement of the hook from the respective engagement portion 34.

Operation of the grip device according to the present invention is evident from what has been described above.

With reference initially to the embodiment shown in FIGS. 4 to 7, if the user wishes to move the frame 10 from the extended condition to the collapsed condition, he acts first of all on the remote actuation means in order to release the locking device or devices 6 and then acts on the actuation devices of the locking/release mechanisms of the frame, of whatever kind they may be.

Likewise, in order to open the frame, first of all the frame is moved to the extended position and then, by means of a slight pressure on the handle itself, the one or more locking devices provided on said grip device is/are moved to the locking condition.

If advantageously the remote actuation means can actuate simultaneously both the locking/release mechanism and the device or devices for locking the grip device, opening and closure are further simplified, since it is sufficient for the user to act on said remote actuation means (provided for example at the lifting handle) in order to release, simultaneously and with a single operation, both the locking/release mechanism and the device or devices for mutually locking the different connecting elements that provide the grip device, so as to allow the transition of the frame from the extended condition to the collapsed condition.

Moreover, if the grip device is provided with the opening sensor, it has been found that the mutual locking of the different connecting elements of the handle can occur only when the frame is in an extended condition, avoiding the possibility that the locking devices (which act on the grip device) might lock the connecting elements of the handle when the frame is not yet fully extended, a situation which would cause a certain difficulty and danger during use and during the mutual locking of the front uprights.

All the characteristics of the invention indicated above as advantageous, convenient or the like may also be omitted or be replaced with equivalents.

The invention thus conceived is susceptible of numerous modifications and variations, all of which are within the scope of the appended claims.

Thus, for example, the remote actuation means can provide for the use of an automatic actuation button, such as a signal transmitter, which is connected wirelessly to the locking device.

In practice it has been found that the invention has achieved the intended aim and objects in all of its embodiments.

In practice, the materials used, as well as the dimensions, may be any according to requirements.

The disclosures in Italian Patent Application No. VR2005A000131 from which this application claims priority are incorporated herein by reference.

What is claimed is:

1-16. (canceled)

17. A grip device, for pushchairs, prams and baby carriages in general, comprising: a connecting body provided with a plurality of connecting elements, which comprise two connecting ends, which are coupled to a respective connecting element provided at a respective side of a frame for pushchairs designed to pass from a closed or collapsed condition to an open or extended condition and vice versa, the grip device having at least two connecting portions, which are articulated to each other and connect said two connecting ends; means for locking said grip device with said frame in an open or extended condition, said locking means comprising at least one locking device, which acts between a pair of contiguously arranged connecting elements and is adapted to lock on command rotation of one connecting element with respect to the other; and means for the remote actuation of said at least one locking device.

18. The grip device according to claim 17, wherein each side of said frame comprises a respective upper and lower front upright and a rear upright and an articulated structure for interconnecting the two rear uprights, a mechanism for mutual locking/release between said upper upright and the respective lower upright being provided on at least one of said two sides for the transition of said frame from said open or extended condition to said closed or collapsed condition and vice versa, said means for the remote actuation of said at least one locking device being designed to actuate said locking/release mechanism, and comprising means for kinematic connection between said locking/release mechanism and said at least one locking device.

19. The grip device according to claim 18, wherein said remote actuation means comprise a lifting handle which is arranged substantially at said articulated interconnection structure.

20. The grip device according to claim 19, wherein said remote actuation means comprise means for kinematic connection between said lifting handle and said locking device.

21. The grip device according to claim 19, wherein said remote actuation means comprise means for kinematic connection between said lifting handle and said locking/release mechanism.

22. The grip device according to claim 18, wherein said kinematic connection means comprise a sheathed cable.

23. The grip device according to claim 18, wherein said means for kinematic connection between said locking/release mechanism and said at least one locking device comprise an actuation rod, which is mounted so that it can slide with respect to the respective upper upright.

24. The grip device according to claim 23, wherein said actuation rod comprises an actuation pin, which can be engaged by a release lever system, which is supported by said locking/release mechanism and can be actuated by said remote actuation means.

25. The grip device according to claim 17, wherein said locking device is provided with an actuation device which is adapted to allow mutual locking between the respective pair of connecting elements only when said frame is in a fully open or extended condition.

26. The grip device according to claim 25, wherein said actuation device comprises an opening sensor which is designed to pass from an active condition, when said frame is in the open or extended condition, to an inactive condition, when said frame is not in the open or extended condition.

27. The grip device according to claim 26, wherein said opening sensor comprises a hook which is pivoted to a lower support which is fixed to said upper upright and is kept engaged, by a loading spring, with a respective engagement portion formed on a respective actuation rod when said frame is in the collapsed condition.

28. The grip device according to claim 27, wherein when said frame is in the extended condition said hook is designed to abut against an abutment portion formed on the lower upright in order to disengage from the respective engagement portion.

29. The grip device according to claim 17, wherein said at least one locking device acts between at least one connecting end and the connecting portion associated therewith, said locking device being adapted to lock the relative rotation of said connecting portion with respect to the respective connecting end.
